(19) United States
(12) Patent Application Publication
(10) Pub. No.: US 2026/0346439 A1
(43) Pub. Date: Nov. 5, 2026

(54) Methods and Devices for Throughput Balancing

(71) Applicant: Zebra Technologies Corporation, Lincolnshire, IL (US)

(72) Inventors: Seth David Silk, Barrington, IL (US); David F. Beck, Exeter, RI (US); Matthew D. Corvese, Cranston, RI (US)

(73) Assignee: Zebra Technologies Corporation, Lincolnshire, IL (US)

(21) Appl. No.: 19/199,348

(22) Filed: May 5, 2025

(51) Int. Cl. B25J 9/16; B41J 3/407

(52) U.S. Cl. CPC B25J 9/1653; B25J 9/1661; B41J 3/4075

(57) ABSTRACT

The present disclosure provides methods and devices for throughput balancing. An example method of throughput balancing is provided by a method of maintaining object throughput of an object transport and processing system, the method comprising: identifying a throughput rate of objects being transported along a processing path; controlling an end effector of a robotic device to operate in a first region of the processing path to apply elements to the objects; identifying a first subset of the objects that will pass through the first region during an offline action during which the end effector ceases to apply the elements to the objects; controlling the end effector of the robotic device to extend an operation of the end effector of the robotic device to a second region upstream of the first region along the processing path to apply elements to each of the objects in the first subset in advance of the offline action; and engaging in the offline action.

### BACKGROUND

A supply chain process of a logistics system, such as a warehousing system, transportation system, sorting systems, and the like, typically involves using media (e.g., printed labels and/or radio frequency identification (RFID) tags) to mark, track, locate, and/or route objects that are being sorted, stored in a location, and/or transported between locations. The objects may have various sizes, shapes, and/or be configured in various positions on a conveyor that is used to process and/or distribute the objects for labelling with the media.

### SUMMARY

In an example embodiment, the present disclosure provides a method of maintaining object throughput of an object transport and processing system, the method comprising: identifying a throughput rate of objects being transported along a processing path; controlling an end effector of a robotic device to operate in a first region of the processing path to apply elements to the objects; identifying a first subset of the objects that will pass through the first region during an offline action during which the end effector ceases to apply the elements to the objects; controlling the end effector of the robotic device to extend an operation of the end effector of the robotic device to a second region upstream of the first region along the processing path to apply elements to each of the objects in the first subset in advance of the offline action; and engaging in the offline action.

In an example variation of this embodiment, the method further includes returning from the offline action; and controlling the end effector of the robotic device to resume operating within the first region of the processing path to apply elements to the objects arriving in the first region after the first subset of the objects.

In an example variation of this embodiment, the method further includes reducing a transport speed of the objects along the processing path from a first speed to a second speed in advance of the offline action in response to determining the throughput rate exceeds a threshold rate; returning from the offline action; and in response to returning from the offline action, increasing the transport speed of the objects along the processing path from the second speed to the first speed.

In an example variation of this embodiment, the second speed is between 50% and 95% of the first speed.

In an example variation of this embodiment, the method further includes returning from the offline action; and controlling the end effector of the robotic device to extend an operation of the end effector of the robotic device to a third region downstream of the first region along the processing path to apply elements to a second subset of the objects that arriving in the third region after the first subset of the objects without first receiving the elements from the end effector in the first region.

In an example variation of this embodiment, controlling the robotic device to apply elements to the second subset of the objects in the third region includes increasing an operating speed of the robotic device.

In an example variation of this embodiment, the method further includes controlling the end effector of the robotic device to resume operating within the first region of the processing path to apply elements to the objects arriving in the first region after the elements are applied to the second subset of the objects.

In an example variation of this embodiment, the end effector includes a thermal printing device.

In an example variation of this embodiment, the elements include adhesive labels.

In an example variation of this embodiment, the elements include radiofrequency identification (RFID) tags, near-field communication (NFC) tags, or Bluetooth tags.

In an example variation of this embodiment, the throughput rate is between 60 and 3600 objects per hour (PPH).

In an example embodiment, the present disclosure provides an object processing system, comprising: an end effector operatively coupled to a robotic device, the end effector configured to apply elements to objects being transported along a processing path; and a logic circuit. The logic circuit is configured to: identify a throughput rate of objects being transported along a processing path; control the end effector of a robotic device to operate in a first region of the processing path to apply elements to the objects; identify a first subset of the objects that will pass through the first region during an offline action in which the end effector ceases to apply the elements to the objects; control the end effector of the robotic device to extend an operation of the end effector of the robotic device to a second region upstream of the first region along the processing path to apply elements to each of the objects in the first subset in advance of the offline action; and engage in the offline action.

In an example variation of this embodiment, the logic circuit is further configured to: return from the offline action; and control the end effector of the robotic device to resume operating within the first region of the processing path to apply elements to the objects arriving in the first region after the first subset of the objects.

In an example variation of this embodiment, the logic circuit is configured to: reduce a transport speed of the objects along the processing path from a first speed to a second speed in advance of the offline action in response to determining the throughput rate exceeds a threshold rate; return from the offline action; and in response to returning from the offline action, increasing the transport speed of the objects along the processing path from the second speed to the first speed.

In an example variation of this embodiment, the second speed is between 50% and 95% of the first speed.

In an example variation of this embodiment, the logic circuit is configured to: return from the offline action; and control the end effector of the robotic device to extend an operation of the end effector of the robotic device to a third region downstream of the first region along the processing path to apply elements to a second subset of the objects that arriving in the third region after the first subset of the objects without first receiving the elements from the end effector in the first region.

In an example variation of this embodiment, the logic circuit is configured to increasing an operating speed of the robotic device.

In an example variation of this embodiment, the logic circuit is configured to: control the end effector of the robotic device to resume operating within the first region of the processing path to apply elements to the objects arriving in the first region after the elements are applied to the second subset of the objects.

In an example variation of this embodiment, the end effector includes a thermal printing device.

In an example variation of this embodiment, the elements include adhesive labels.

In an example variation of this embodiment, the elements include radiofrequency identification (RFID) tags or near-field communication (NFC) tags.

In an example variation of this embodiment, the throughput rate is between 60 and 3600 objects per hour.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the subject matter of this disclosure.

### BRIEF DESCRIPTION OF THE DRAWINGS

FIG. 1 illustrates an autonomous media application system, according to embodiments of the present disclosure.

FIG. 2A illustrates an end effector of the autonomous media application system of FIG. 1, according to embodiments of the present disclosure.

FIG. 2B illustrates a block diagram of the end effector of FIG. 2A, according to embodiments of the present disclosure.

FIG. 3 illustrates a detailed view of some components of the autonomous media application system of FIG. 1, according to embodiments of the present disclosure.

FIG. 4 illustrates a flowchart of a method for applying elements to objects as the objects are being transported along a processing path, according to embodiments of the present disclosure.

FIG. 5 illustrates a diagram of a receiving surface of an object subdivided into sections.

FIG. 6 illustrates a diagram of two co-located objects as may be processed by the autonomous media application system of FIG. 1, according to embodiments of the present disclosure.

FIG. 7 illustrates a method for calculating a course of motion, according to embodiments of the present disclosure.

FIGS. 8A-8B illustrates a logic function representing the method of FIG. 7 and portions of the Method of FIG. 4, according to embodiments of the present disclosure.

FIG. 9 illustrates a flowchart of a method for maintaining throughput of an object transport and processing system, according to embodiments of the present disclosure.

FIG. 10 illustrates a logic function representing the method of FIG. 9, according to embodiments of the present disclosure.

In several of the figures of the present disclosure, a shared coordinate system is used (as indicated with the compasses in individual figures) with X, Y, and Z directions to aid in understanding. Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

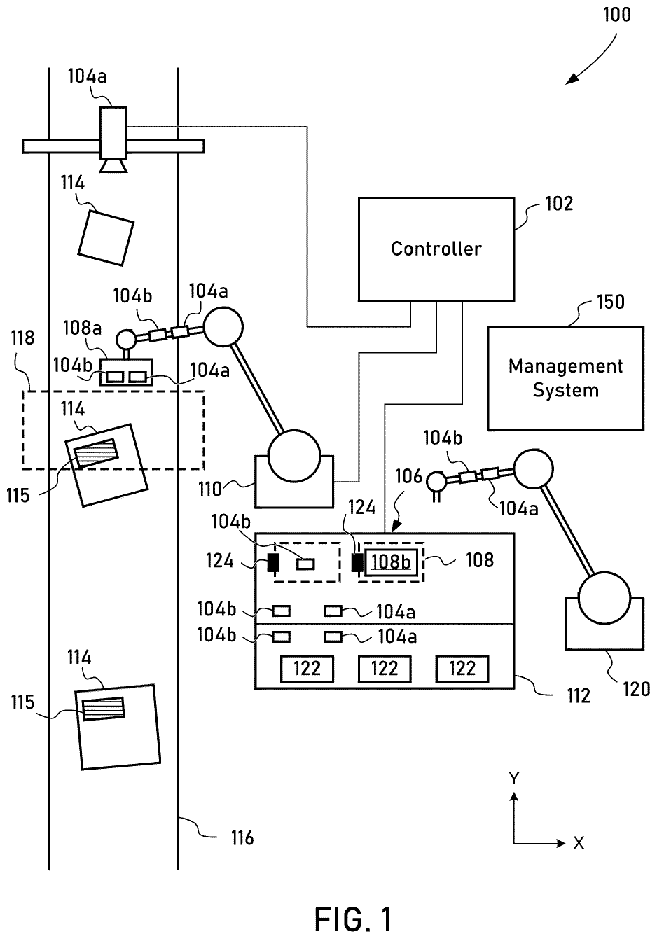

FIG. 1 illustrates an example system 100 (e.g., autonomous media application system) and an example management system 150 in accordance with embodiments of the present disclosure. The system 100 includes a system controller 102 (e.g., a logic circuit), one or more cameras 104a and/or one or more sensor 104b (e.g., proximity sensors, optical sensors, inertial sensors, etc.), a docking station 106, one or more end effectors in the form of end effectors 108a-b (collectively 108), one or more robotic devices 110 and 120, e.g., in the form of robotic arms, and a media replenishment system 112. The system controller 102 can include a processor, memory, communication interfaces, I/O interfaces, and/or other components to perform the operations and/or function described herein. Embodiments of the system 100 may include multiple end effectors 108 and/or multiple robotic devices 110 and 120 to reduce or prevent downtime and/or a likelihood of a shutdown of the system 100.

As shown in FIG. 1, objects 114 may be conveyed by a conveyor system 116 (e.g., processing path) into an application zone 118, within which the system 100 may autonomously apply elements 115 (e.g., media elements, media, such as labels) to the objects 114 via one of the end effectors 108 (e.g., media applicators). In some implementations, the conveyor system 116 may be associated with and/or form part of the system 100. In such a case, the system 100 may control a speed and/or direction of one or more the conveyors of the conveyor system 116, e.g., via the controller 102, in order to control a speed and/or direction of objects 114 on the conveyor system 116.

The docking station 106 can store the end effectors 108 and/or can present one or more of the end effectors 108 to the robotic device 110, such as a robotic arm, which can be controlled (e.g., by the controller 102) to connect to one of the end effectors 108. For example, the robotic device 110 can be attached to a first end effector 108a while a second end effector 108b remains in the docking station 106. In some implementations there may be single end effector 108 and the system 100 may be devoid of the docking station 106 or may include the docking station 106 for storing the first end effector 108a when the first end effector 108a is not attached to the robotic device 110. For embodiments that include the docking station 106, the docking station 106 can include or be associated with the robotic device 120, such as a robotic arm, separate from the robotic device 110, that can be controlled to store the end effectors 108, present the end effectors 108 to the robotic device 110 for attachment to the robotic device 110, and/or to replenish supplies of media in the end effectors 108 via the media replenishment system 112. In some implementations, the docking station 106 and the system 112 may be integrated with one another. In some implementations, the docking station 106 may be a static (non-robotic) mechanical structure with electrical interfaces for supporting and communicating with the end effectors 108. While an example embodiment of the docking station 106 has been illustrated as including as being configured to dock multiple end effectors 108, exemplary embodiments of the docking station 106 may be configured to dock a single media applicator such that a separate docking station may be required for each end effector 108.

The robotic device 110 may be attached to the end effectors 108 using any suitable technique. As an example, the robotic device 110 may be attached to the end effector 108a via one or more couplers, e.g., mechanical, electrical, and/or electromechanical couplers. The one or more couplers of the robotic device 110 may include one or more electrical terminals that facilitate communication between the robotic device 110 and the media applicator to which the robotic device 110 is attached (e.g., the end effector 108a in the present example). Additionally, or alternatively, the one or more couplers may be configured for transfer of electrical power from the robotic device 110 to one or more components of the attached end effector 108a to power the one or more components.

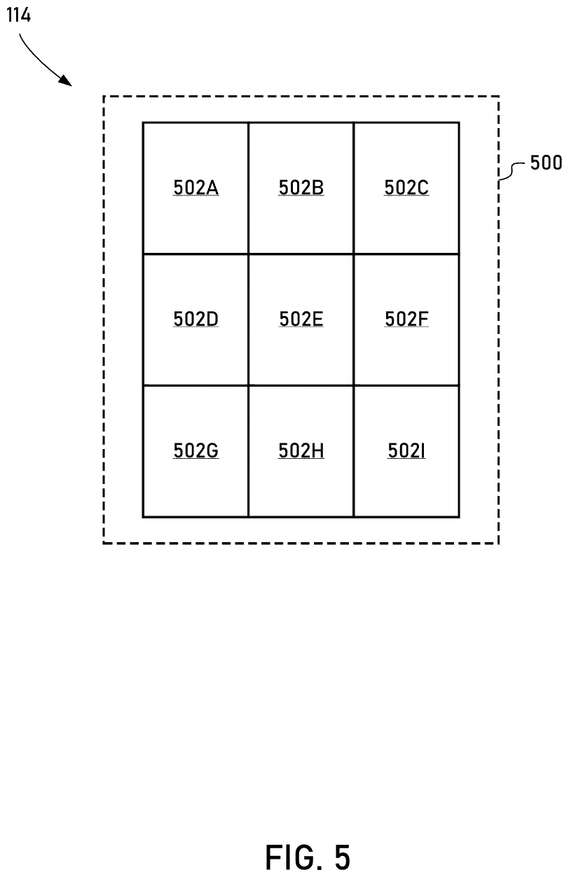

The robotic device 110 may be autonomously controlled by the controller 102 to move the attached end effector 108a relative to the objects 114 and the attached end effector 108a may be controlled to print, encode, and/or apply elements 115 to the objects 114. For example, the objects 114 may be conveyed by the conveyor system 116 through an application zone 118, and the controller 102 may control the robotic device 110 to move the end effector 108a into position to align the end effector 108a with a specified area of the object 114 (e.g., a receiving surface, see FIG. 5), and may control the end effector 108a to print, encode, and/or apply elements 115 to the objects 114 as the objects 114 move along the conveyor system 116, e.g., through the application zone 118. The controller 102 may also autonomously control the robotic device 110 to move the end effector 108a into position relative to docking station 106 to release the end effector 108a for storage by the docking station 106 and/or to move the end effector 108a into position relative to the media replenishment system 112 to facilitate media replenishment.

Outputs of the one or more cameras 104a and/or the one or more sensors 104b may be used by the controller 102 of the system 100 to autonomously control an operation of the docking station 106, the end effectors 108, the robotic device 110, and/or the replenishment system 112. The one or more sensors 104b may be mounted on the docking station 106, the end effectors 108, the robotic device 110, the media replenishment system 112, and/or at other locations. The controller 102 may receive outputs from the one or more sensors 104b to determine a position of robotic device 110, a position of the end effector 108a relative to the docking station 106 and/or the media replenishment system 112; and/or to determine a status of the docking station 106, the end effector 108a, the robotic device 110, the media replenishment system 112, the objects 114, and/or the conveyer system 116. As another example, the controller 102 of the system 100 may receive images (or video that includes multiple image frames) of the objects 114 being conveyed on the conveyor system 116 from the one or more cameras 104a and/or may receive images of a position of the end effector 108a and/or the robotic device 110. In some implementations, the one or more cameras 104a may be disposed in various locations throughout the physical environment within which the system 100 is implemented. For example, one of the cameras 104a may be mounted to a support structure (e.g., a gantry) of the conveyor system 116, the docking station 106, the end effectors 108, the robotic device 110, and/or the media replenishment system 112. As one example, one of the cameras 104a may be mounted to the end effector 108a in order to permit the controller 102 of the system 100 to monitor a portion of the conveyor system 116, determine and track positions of the objects 114 on the conveyor system 116, determine and track a position of the end effector 108a, e.g., to align the end effector 108a with objects 114 to facilitate labeling the objects 114 and/or to align the end effector 108a with the media replenishment system 112 to facilitate autonomous reloading of the end effector(s) 108 with media supplies 122 managed by the media replenishment system 112. The one or more cameras 104a may be configured to stream images depicting a portion of the conveyor system 116 that receives the objects 114 before the objects 114 reach the application zone 118 on the conveyor system 116. In this way, via the streamed images, the system 100 may monitor the conveyor 116 to detect the incoming objects 114 that are to receive media from one of the end effectors 108.

The controller 102 of the system 100 may process the images of the objects 114 captured by the camera(s) 104a using an image processing model that is configured to identify one or more characteristics of the object (e.g., positions of the objects 114 on the conveyor system 116, sizes of the objects 114, shapes of the objects 114, types of the objects 114, identifiers of the objects 114, and/or media receiving areas on the objects 114, among other characteristics). The position of the objects 114 (which may be referred to herein as “object positions”) may include or be defined by an orientation of the object (e.g., relative to a center axis or other reference point of the conveyor system, relative to a location of the camera, and/or relative to a location of the robotic arm), and/or a location of the objects 114 on the surface of the conveyor system 116 (e.g., relative to a reference point of the conveyor system, relative to a location of the camera, and/or relative to a location of the robotic arm). The image processing model may utilize any suitable computer vision technique to identify the object within the image and/or determine one or more characteristics of the object as described herein. For example, a computer vision technique of the image processing model may include one or more of an image recognition technique (e.g., an Inception framework, a ResNet framework, and/or a Visual Geometry Group (VGG) framework), an object detection technique (e.g., a Single Shot Detector (SSD) framework, and/or a You Only Look Once (YOLO) framework), an object in motion technique (e.g., an optical flow framework), an optical character recognition technique, among other examples.

In some implementations, the image processing model may be executed by the controller 102 to analyze the one or more images to detect specific and/or unique characteristics associated with a particular object. For example, because individual objects may be configured to receive different labels (rather than a same label being applied to every object), the objects may include an object identifier, such as a text identifier, a barcode, or other unique marking that is known and/or associated with the label application system and/or label management system. As an example, a first one of the objects 114 may be identified by an object identifier “1-X,” and a second one of the objects 114 may be identified by an object identifier “2-Z.” In some implementations, the individual characters may be associated with certain mappings and/or codes that may be interpreted by the controller 102 to identify content that is to be printed on media to be applied or affixed to the objects 114, to identify a type of media that is to be applied to the objects 114, to identify a type of end effector 108 that is to be selected for the objects 114, and so on. Accordingly, the system 100 using the image processing model may identify and/or detect object identifiers on objects depicted in the images.

The system 100 may receive instructions from the management system 150. The instructions may indicate content that is to be printed on and/or encoded the elements 115 (e.g., or directly on the objects 114) by one or more of the end effectors 108 (e.g., the end effector 108a in the present example). In some implementations, the instructions may be different for each of the objects 114 or may be the same for multiple objects 114. As an example, the instructions may be the same for all objects 114 or a set of objects 114. As another example, the system 100 may receive individual instructions for individual objects 114 (or types of objects) that are being conveyed by the conveyor 116. For example, the instructions may indicate that one of the objects 114 that has a particular characteristic (e.g., a particular identifier or is a particular type) is to receive an element 115 including media with corresponding content. Accordingly, based on identifying and/or detecting an object identifier of the particular one of the objects 114, the system 100 may determine content that is associated with the object identifier to permit the media application system to print the content to media and/or encode the content in an RF tag, NFC tag, or Bluetooth tag of the media and subsequently apply the media to the particular one of the objects 114.

In one example, embodiments of the end effectors 108 may be media processing device configured to process (e.g., print, encode, etc.) media by drawing the media from the media source and routing the media proximate to various media processing components (e.g., printhead(s), RFID/NFC reader/encoder, magnetic stripe reader/encoder, Bluetooth reader/encoder etc.). Processing the media from the media source may facilitate a continuous or batch printing and/or encoding process. As an example, embodiments of end effector 108a may be configured to print and/or encode media drawn from a media source, such as a roll of media, installed in the end effector 108a. The media may include a continuous web such as a spool of lined or linerless media. As a non-limiting example, the continuous web of media may be coated on one surface with a pressure sensitive adhesive and may include a printable surface on the opposite surface. For lined media, the media may include a release liner overlaying the adhesive that may be removed to expose the adhesive when the media is output from the media processing devices and/or when the media will be affixed to an object. For linerless media, the media is devoid of the release liner. For thermal transfer printing, the printable surface of the linerless media is configured to receive a pigment (e.g., ink, resin, wax-resin, etc.) that is transferred from a ribbon supply. For direct thermal printing, a thermal printhead of the media applicator directly contacts the printable surface triggering a chemical and/or physical change in a thermally sensitive dye covering and/or embedded in at least a portion of the printable surface of the media. In addition, or in the alternative, the media may include a radiofrequency identification device (RFID) or near-field communications (NFC) inlay that may be written to and/or read by a RFID/NFC encoder. In addition, or in the alternative, the media may include a Bluetooth tag or device that may be written to and/or read by a Bluetooth enabled encoder.

The web of media is routed along a media path in the end effector 108a from the media supply to a print and/or encoding position located adjacent to the printhead (e.g., a thermal printhead) and/or the RFID/NFC encoder. The position of components of the end effector 108a relative to other components may be defined based on the flow of media along the media path from the media source to the outlet and/or a take-up spindle. For example, the media source installed in the end effector 108a is upstream of the printhead, the printhead is downstream of the media source (the web of media), and the outlet of the end effector 108a is downstream of the media source and the printhead along the media path. The continuous web of media may be pulled through the media path by a driven platen roller. The printhead is generally configured to form a nip with the platen roller to pinch the media between the printhead and the platen roller. In addition to pulling the media, or in the alternative, this pinching or compressive force aids in achieving adequate print quality. Once printed and/or encoded, the printed and/or encoded portion of the media may be advanced outwardly from the printer through a media outlet by the platen roller where it may be cut and/or torn to separate the printed and/or encoded media from the media supply. For media that includes a liner, the media processing device may also include a peeler downstream of the nip formed by the printhead and the platen roller. The peeler may separate the liner from the media such that the media is output from the media processing device with the adhesive of the media exposed, while the liner may be wound on the take-up spindle.

During use of the end effector 108a by the system 100, the end effector 108a and/or the controller 102 may be configured to determine that the supply of media in the end effector 108a is depleted or will be depleted soon (e.g., an amount of media remaining in end effector 108a is less than a specified amount of media). The end effector 108a and/or the controller 102 may determine that the supply of media is depleted or will soon be depleted using any suitable techniques. As one example, the end effector 108a may include one or more sensors 104b configured to detect when the supply of media is depleted or will soon be depleted and may output a signal to the controller 102. As another example, a quantity of the media remaining may be calculated or estimated based on, for example, on an initial quantity of media loaded into the end effector 108a, and a quantity of media that has been dispensed by the end effector 108a, which may be based determined on one or more of a number of print jobs executed by the end effector 108a, a number of revolution of a payout spindle of the end effector 108a (e.g., steps of a stepper motor, measured by a rotary encoder, etc.), a print speed, a starting diameter of a media roll, a thickness of the media, a length of media units dispensed by the end effector 108a, and/or other information.

When the end effector 108a and/or controller 102 determines that the supply of media is depleted or will be depleted soon (or in some scenarios when different media is required) the controller 102 may control the robotic device 110 to move the media applicator, e.g., end effector 108a, to the docking station 106 (e.g., for embodiments in which the docking station 106 is configured to facilitate installation of media in the end effector 108a) or to the media replenishment system 112 to facilitate installation of the media in the end effector 108a. As an example, the controller 102 may control the robotic device 110 and/or the end effector 108a to autonomously discard the remaining media, media core(s), and/or media frames/cartridges from the end effector 108a and to autonomously install a new supply of media into end effector 108a via an interaction with the media replenishment system 112. Alternatively, or in addition, for embodiments in which the docking station 106 is configured to facilitate installation of a new supply of media in the end effectors 108 (e.g., via robotic device 120), when the robotic device 110 returns the end effector 108a to the docking station 106, the robotic device 110 may attach to the end effector 108b, which may already have a new supply of media installed therein such that the robotic device 110 does not need to wait for the installation of a new media supply in the end effector 108a and may resume operation with the end effector 108b, which may result in reduced downtime of the system 100. The controller 102 may control the robotic device 120 associated with the docking station 106 and/or the end effector 108a to autonomously discard the remaining media, media core(s), and/or media frames/cartridges from the end effector 108a and to autonomously install a new supply of media into end effector 108a via an interaction with the media replenishment system 112. In some implementations, the controller 102 may also control the media replenishment system 112 to stage the supply of media for installation in the end effector 108a. As one example, the media replenishment system 112 may be configured to stage the supply of media to aid in installation of the supply of media in the end effectors 108.

In one example, the supply of media to be installed in the end effector 108a may include a media roll wound about a first core. In some instances, for example for media with a liner, the supply of media may include a second core that is attached to a terminal end of a liner of the media. During operation as the media is output by the end effector 108a, the liner may be separated from the media (e.g., by the peeler) and wound about the second core. For media that is devoid of a liner (linerless media), the media may be devoid of the second core. When a new supply of media is installed into the end effector 108a, the first core of the supply of media is mounted on a payout spindle of the end effector 108a and the media is routed through the end effector 108a along a media path before the end effector 108a may utilize the supply of media. The media replenishment system 112 may present the supply of media to the end effector 108a such that the first core of the supply of media may be autonomously received by the payout spindle and so that the media may be autonomously routed through the end effector 108a along the media path. For embodiments of the supply of media that include the second core, the media replenishment system 112 may be configured to present the supply of media to the end effector 108a such that the second core of the supply of media may be autonomously received by the take-up spindle of the end effector 108a.

As indicated above, FIG. 1 is provided as an example of a media application system. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

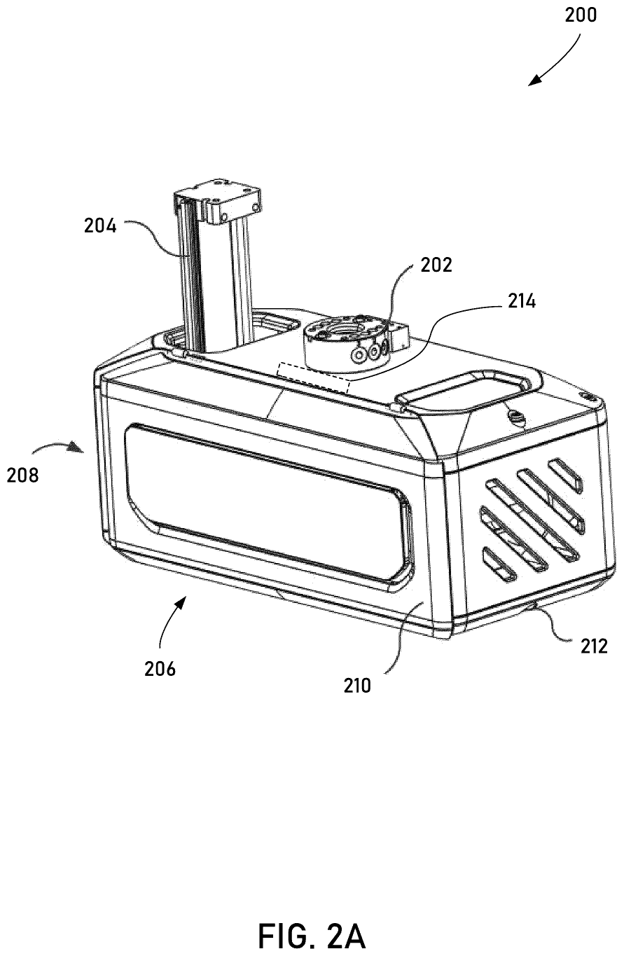

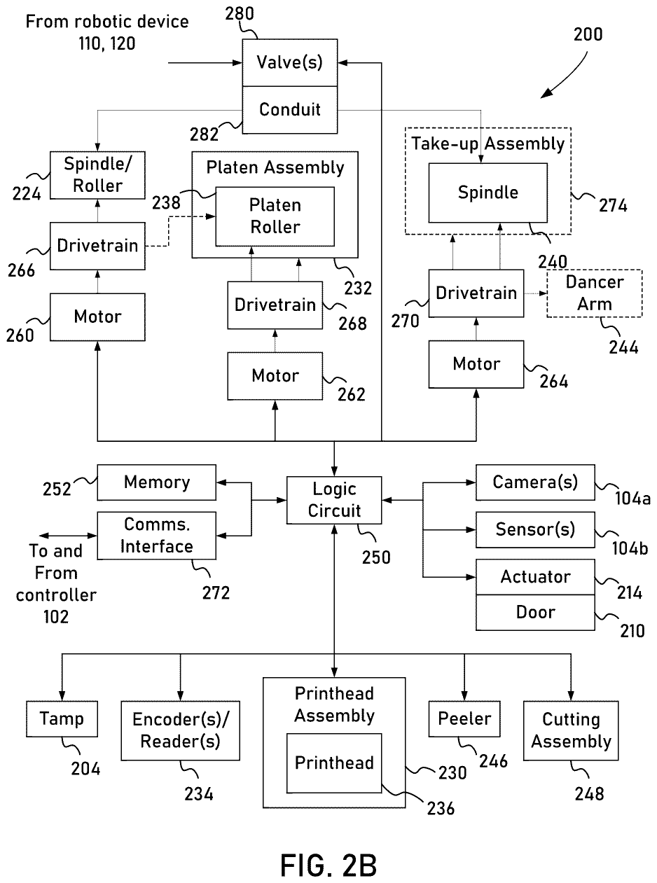

FIG. 2A illustrates an example embodiment of a media applicator 200 which may be embodied as one or more of the end effectors 108 shown in FIG. 1, for example, the end effector 108a. As shown in FIG. 2A, the media applicator 200 includes a housing 206, an electromechanical coupling 202 and a tamp 204. The tamp 204 may be positioned toward an output side 208 of the media applicator 200 from which a media is output from the media applicator 200. The tamp 204 may be hydraulically actuated (e.g., using an air-powered vacuum generator), pneumatically actuated, and/or electromechanically actuated (e.g., using a motor). In one example, the media applicator 200 includes a media door or other moveable barrier 210 that facilitates access to an interior volume of the media applicator 200 and to components within the media applicator 200 for handling the media during an operation of the media applicator 200 (e.g., a payout roller, a take-up roller, a printhead, an RFID/NFC encoder, a platen roller, a peeler, a cutter, dancer arms, and/or other components of the media applicator 200). In some implementations, the media door 210 may be opened via an actuator 214 of the media applicator 200.

The media applicator 200 includes a dock terminal 212 that is configured to couple with a dock interface 124 of the docking station 106 illustrated in FIG. 1. The dock terminal 212 may enable the controller 102 to communicate with the media applicator 200 and/or supply power to the media applicator 200 via the dock interface and/or the docking station 106. In some implementations, the controller 102 may cause the actuator 214 to automatically open the media door 210 upon the media applicator 200 being returned to a dock of the docking station 106 and/or upon the media applicator 200 receiving power from the dock interface 124 of the docking station 106 via the dock terminal 212 (e.g., to facilitate replenishment of media in the media applicator 200 via the replenishment system 112). In some implementations, the media applicator 200 may include a battery. For example, the battery may store an electric charge that is used to power one or more components of the media applicator 200. The electric charge may be received via the dock terminal 212 when the media applicator 200 is placed in a dock of the docking station 106 and/or may be received via the electromechanical coupling 202 when the media applicator 200 is attached to the robotic device 110. Alternatively, the media applicator 200 may be devoid of a battery and may receive power from robotic device 110 via the electromechanical coupling 202 and/or from the docking station 106 via the dock terminal 212.

As indicated above, FIG. 2A is provided as an example of a media applicator. Other examples may differ from what is described with regard to FIG. 2A. The number and arrangement of devices/components shown in FIG. 2A are provided as an example. In practice, there may be additional devices/components, fewer devices/components, different devices/components, or differently arranged devices/components than those shown in FIG. 2A. Furthermore, two or more devices/components shown in FIG. 2A may be implemented within a single device/component, or a single device/component shown in FIG. 2A may be implemented as multiple, distributed devices/components. Additionally, or alternatively, a set of devices/components (e.g., one or more devices/components) shown in FIG. 2A may perform one or more functions described as being performed by another set of devices/components shown in FIG. 2A.

FIG. 2B illustrates an example block diagram for an embodiment of the media applicator 200 that can be embodied as the media applicators 108a and/or 108b shown in FIG. 1. As shown in FIG. 2B, the media applicator 200 can include: a media payout roller or a media supply spindle 224 that can hold or support a media spool or media roll; a printhead assembly 230 including a printhead 236; a moveable platen assembly 232 including a platen roller 238; a RFID/NFC encoder 234; a take-up roller or spindle 240; a dancer arm 244 configured to engage the media at one or more positions along a media path; a peeler 246; a cutting assembly 248; the tamp 204; as well as electronics and drive components including, for example, a logic circuit 250 (e.g., such as a processor, FPGA, ASIC, or other logic circuit); a non-transitory computer-readable medium, e.g., in the form of memory 252; at least one of the one or more of the cameras 104a; at least one of the one or more of the sensors 104b; motors 260, 262, and/or 264; drive trains 266, 268, and/or 270; a communications interface 272; the actuator 214 operatively coupled to the access door 210; and/or valves 280 operative coupled to conduit 282 and the spindles 224 and/or 240 to output a flow air under pressure from the spindles 224 and/or 240 to aid in discarding remnants of media components after the supply of media has been depleted. In one example, the peeler 246 can form part of the platen assembly 232. In one example, the take-up spindle 240 can be part of a moveable take-up assembly 274 such that, e.g., the take-up spindle 240 is moveable in a direction that is transverse to an axis of rotation of the take-up spindle 240, as described herein. In other examples, the media applicator 200 can be devoid of the moveable take-up assembly 274 such that an axis of rotation of the take-up spindle 240 is generally fixed. The drive trains 266, 268, and/or 270 can include driveshafts, gears, belts, clutches, and/or other components configured to transfer motion from the motors 260, 262, and/or 264 to the spindle 224, the platen roller 238 and/or platen assembly 232, the spindle 240, spindle assembly 274, and/or dancer arm 244.

The logic circuit 250 can send instructions and/or data to and/or receive instructions and/or data from the system controller 102 (e.g., via the communications interface 272). The logic circuit 250 can execute code stored in the memory 252 to control the components of the media applicator 200 to perform one or more media processing functions, for example, in response to instructions and/or data received from the system controller 102. As one example, the logic circuit 250 can execute code in the memory 252 to control a rotation of the media supply spindle 224 about a media supply spindle axis of rotation via the motor 260 and drive train 266, to control a rotation of the platen roller 238 about a platen roller axis of rotation via the motor 262 and the drive train 268, and/or to control a rotation of the take-up spindle 240 about a take-up spindle axis of rotation via the motor 264 and the drive train 270 to process and/or dispense media from the media applicator 200. The logic circuit 250 can also execute code in the memory 252 to write data to and/or read data from RFID/NFC tags in and/or associated with the media using the encoder/readers 314, render indicia on the media using the printhead 316, peel media from a liner using the peeler 326, and/or cut the media using the cutting assembly 328. In one example, the media applicator 200 may be devoid of the logic circuit 250 and a logic circuit (e.g., a processor) of system controller 102 performs the functions and operations of the logic circuit 250 described herein.

The logic circuit 250 can receive signal(s) output by the sensor(s) 104b and/or images output by the camera(s) 104a and can execute code in the memory 252 to determine, based on the signal(s) and/or image(s), that the media in the media applicator 200 has been depleted or that less than a specified amount of media remains in the media applicator 200. Alternatively, or in addition, the logic circuit 250 can execute code in the memory 252 to determine that the media in the media applicator 200 has been depleted or that less than a specified amount of media remains in the media applicator 200 based on information about the media when it is loaded in the media applicator and information about the consumption of the media by the media applicator 200. As an example, a quantity of the media remaining in the media applicator 200 can be calculated or estimated by the logic circuit 250 based on, for example, on an initial quantity of media loaded into the media applicator 200, and a quantity of media that has been dispensed by the media applicator 200, which may be based on determined on one or more of a number of print jobs executed by the media applicator 200, a number of revolution of the payout spindle 224 (e.g., as determined by a number of steps of the motor 260, as measured by one of the sensors 104b in the form of a rotary encoder, etc.), a print speed (e.g., as determined based on a speed at which the platen roller 238 is driven by the motor 262 and drive train 268), a starting diameter of a media roll, a thickness of the media, a length of media units dispensed by the media applicator 200, and/or other information. In response to determining that the media has been depleted or that less than a specified amount of media remains in the media applicator, the logic circuit 250 can communicate with the system controller 102 via the communications interface 272 to indicate that the media has been depleted or that less than a specified amount of media remains in the media applicator 200 and the system controller 102 can control the robotic device to which the media applicator 200 is attached (e.g., the robotic device 110 or 120) to move the media applicator 200 into position to facilitate replenishment of the media via the media replenishment system 112, e.g., shown in FIG. 1.

In another example, the system controller 102 can receive signal(s) output by the sensor(s) 104b and/or images output by the camera(s) 104a and can determine, based on the signal(s) and/or image(s), that the media has been depleted or that less than a specified amount of media remains in the media applicator 200. In response to determining that the media has been depleted or that less than a specified amount of media remains in the media applicator 200, the system controller 102 can control the robotic device to which the media applicator 200 is attached (e.g., the robotic device 110 or 120) to move the media applicator 200 into position to facilitate replenishment of the media via the media replenishment system 112, e.g., shown in FIG. 1, and can communicate with the media applicator 200 (e.g., the logic circuit 250 via the communications interface 272). In response to the communication from the system controller 102, the logic circuit 250 can be configured to control the media applicator 200 to prepare the media applicator 200 for receiving a supply of media. Alternatively, the system controller 102 can be configured to control the media applicator 200 to prepare the media applicator for receiving a supply of media for embodiments in which the media applicator is devoid of the logic circuit 250.

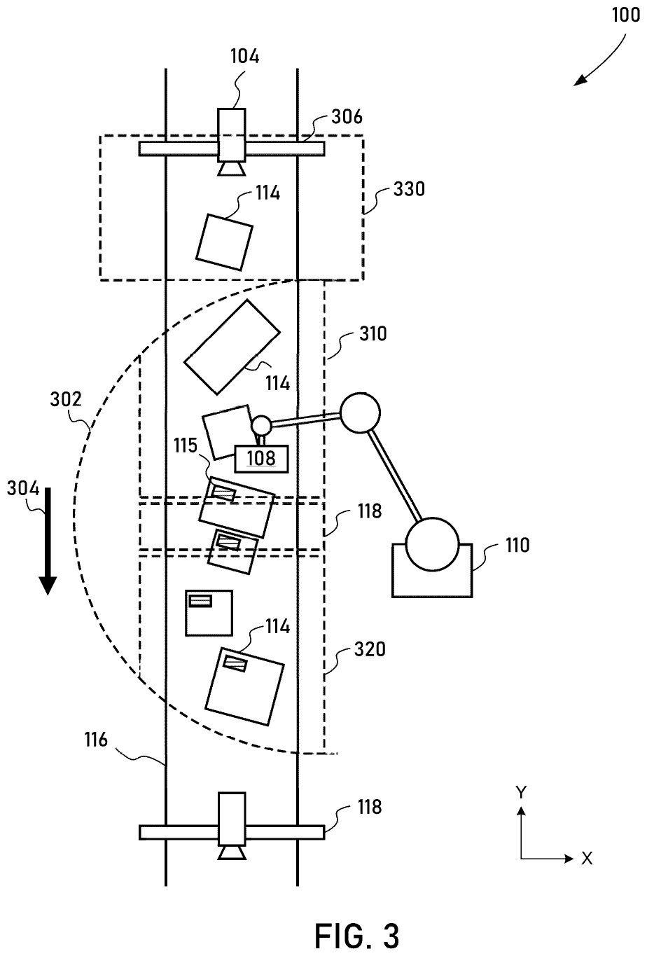

FIG. 3 illustrates a detailed view of the system 100, in which certain features are emphasized and detailed, according to embodiments of the present disclosure. Generally, the robotic device 110 is disposed proximately to the conveyor 116, and has a reach radius 302. Generally, the robotic device 110 may articulate the end effector 108 throughout the space within the reach radius 302. In some examples, the system 100 is controlled to minimize movement of the end effector 108 such that the robotic device 110 articulates the end effector 108 to apply elements 115 to objects 114 and remain in the application zone 118. The application zone 118 may have predetermined dimensions, which are defined within the reach radius 302 of the robotic device 110. The predetermined dimensions of the application zone 118 may be tailored to various use cases, and in some examples may vary corresponding to the nominal speed of the conveyor(s) of the conveyor system 116, a nominal throughput of the system 100, and other such factors. Generally, the dimensions of the application zone 118 may be defined in order to increase an efficiency of the system 100 under normal operating conditions (e.g., as may be defined according to particular use cases).

The application zone 118 is configured such that each object 114 on the conveyor system 116 will be transported through the application zone 118 via the motion of the conveyor system 116. Thus, provided there exists sufficient spacing between objects 114 in the feed direction (e.g., along the y-axis in the illustrated embodiment), the robotic device 110 may reach (e.g., and apply an element to) each object 114 in sequence while moving exclusively in the X and Z directions (or with limited movement in the Y direction), as motion in the Y direction is provided by the conveyor 116 moving objects 114 in the feed direction 304.

The system may further include an upstream zone 310 which is defined in the area between the application zone 118 and within extent of the reach radius 302 of the robotic device 110 in an upstream direction (e.g., opposite the feed direction 304) of the conveyor system 116. Similarly, the system 100 may include a downstream zone 320 which is defined in the area between the application zone 118 and the extent of the reach radius 302 of the robotic device 110 in the downstream direction (e.g., in the feed direction 304) of the conveyor system 116. In various examples, the robotic device 110 may be selectively controlled to expand or change from the application zone 118 to the upstream zone 310 and/or the downstream zone 320 to articulate the end effector 108 and apply elements to objects in the application zone 118, the upstream zone 310, and/or in the downstream zone 320.

In some examples, the system 100 includes a scan gate 306, which is located upstream of the robotic device 110 on the conveyor system 116. The scan gate 306 may include one or more cameras 104a or sensors 104b configured to monitor objects transported through the scan gate 306 along the conveyor 116. The scan gate 306 may be configured to obtain dimensional data of the objects 114 being transported along the conveyor system 116, or more specifically, objects 114 approaching the application zone 118. In various examples, the dimensional data may include one or more of: information which identifies each object, physical dimensions of each object, the positions of each object relative to one another, the positions of each object relative to the conveyor (e.g., spacing data), the position of any pre-existing labels which may be present on each object, and a height of each object relative to a surface of the conveyor 116. The scan gate 306 may communicate the dimensional data of the objects 114 to the controller 102. The scan gate 306 may define a capture zone 330 in which the scan gate 306 may obtain the dimensional data of the objects 114. The capture zone 330 may be defined by a field-of-view (FOV) of the one or more cameras 104a and/or sensors 104b included in the scan gate 306. In various examples, the capture zone may overlap with a portion of the upstream zone 310.

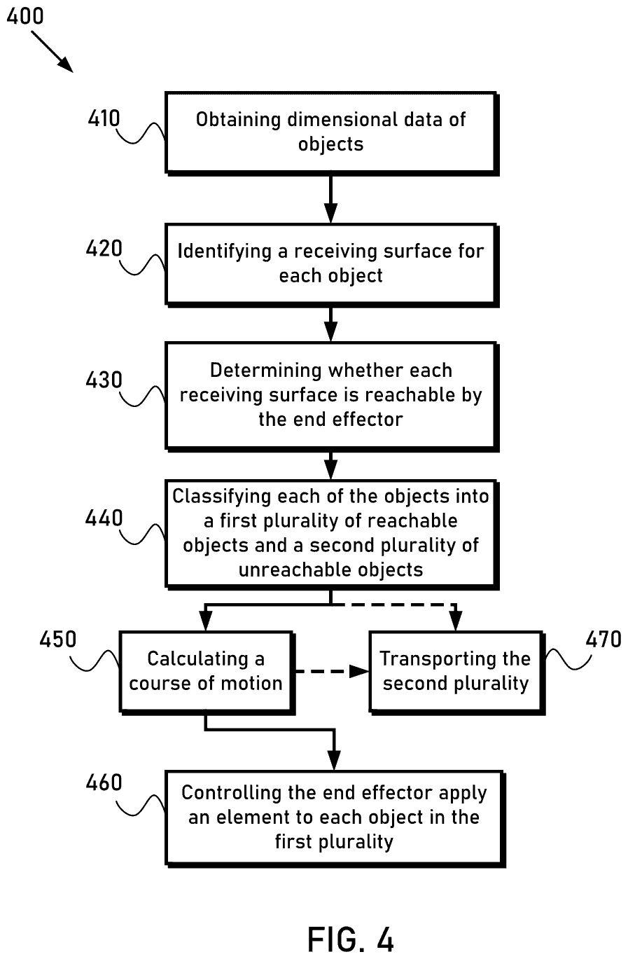

FIG. 4 illustrates a flowchart of an example method 400 of applying elements to objects (e.g., objects 114) as the objects are being transported along a processing path (e.g., conveyor system 116) at a specified processing speed, according to embodiments of the present disclosure. Generally, the objects 114 are items which are being transported along a processing path (e.g., conveyor system 116) and are intended to have elements 115 applied thereon. The objects 114 may be parcels, such as packages, boxes, bins, crates, or bags which may contain other items. The objects 114 may be items of manufacture, units of processed goods, or similar items. The elements to be applied to the objects may be media elements, such as adhesive labels, which may include printed indicia, RF tags, NFC tags, or Bluetooth tags, although other elements are contemplated. In various examples, the system 100 may be configured to execute the method 400.

Generally, the method 400 is a method for determining which objects 114 are reachable by the end effector 108 (e.g., as articulated by the robotic device 110) and applying elements 115 to the objects. The method 400 may be particularly useful when processing objects 114 which are not sorted, aligned, or justified with respect the conveyor system 116, and variable spacing exists between the objects 114. The method 400 may also be applied to objects which are justified with respect to the conveyor system 116 (e.g., aligned along a right or left side of the conveyor system 116) and have predetermined or non-variable spacing between objects 114.

Block 410 of the method 400 describes obtaining dimensional data of objects, according to embodiments of the present disclosure. Particularly, the dimensional data may be obtained by a controller (e.g., controller 102) from a scanning or imaging apparatus (e.g., cameras 104a and/or sensors 104b of the scan gate 306). The dimensional data may include dimensions of each object, such as heights, lengths, and widths of each object, the degree of rotation of each object, the position of one or more objects relative to another object or objects, the position of one or more objects relative to a feature of the processing path (e.g., edge of the conveyor) and the position of any pre-existing labels which may be present on each object.

In the context of the relevant illustrated embodiments (e.g., FIGS. 1 and 3), image data pertaining to objects 114 on the conveyor system 116 may be obtained by the cameras 104a and/or the sensors 104b of the scan gate 306 and transmitted to the controller 102. The controller 102 of the system 100 may process the image data of the objects 114 captured by the scan gate 306 using an image processing model that is configured to identify one or more characteristics of the object (e.g., positions of the objects 114 on the conveyor 116, sizes of the objects 114, shapes of the objects 114, types of the objects 114, identifiers of the objects 114, and/or media receiving areas on the objects 114, among other characteristics). The position of the objects 114 (which may be referred to herein as “object positions”) may include or be defined by an orientation of the object (e.g., relative to a center axis or other reference point of the conveyor, relative to a location of the camera, and/or relative to a location of the robotic arm), and/or a location of the objects 114 on the surface of the conveyor system 116 (e.g., relative to a reference point of the conveyor, relative to a location of the camera, and/or relative to a location of the robotic arm). The image processing model may utilize any suitable computer vision technique to identify the object within the image and/or determine one or more characteristics of the object as described herein. For example, a computer vision technique of the image processing model may include one or more of an image recognition technique (e.g., an Inception framework, a ResNet framework, and/or a Visual Geometry Group (VGG) framework), an object detection technique (e.g., a Single Shot Detector (SSD) framework, and/or a You Only Look Once (YOLO) framework), an object in motion technique (e.g., an optical flow framework), an optical character recognition technique, among other examples.

In some implementations, the image processing model may be executed by the controller 102 to analyze the one or more images to detect specific and/or unique characteristics associated with a particular object. For example, because individual objects may be configured to receive different labels (rather than a same label being applied to every object), the objects may include an object identifier, such as a text identifier, a barcode, or other unique marking that is known and/or associated with the label application system and/or label management system. As an example, a first one of the objects 114 may be identified by an object identifier “1-X,” and a second one of the objects 114 may be identified by an object identifier “2-Z.” In some implementations, the individual characters may be associated with certain mappings and/or codes that may be interpreted by the controller 102 to identify content that is to be printed on media to be applied or affixed to the objects 114, to identify a type of media that is to be applied to the objects 114, to identify a type of end effector 108 that is to be selected for the objects 114, and so on. Accordingly, the system 100 using the image processing model may identify and/or detect object identifiers on objects depicted in the images.

Block 420 of the method 400 describes identifying a receiving surface of each object, according to embodiments of the present disclosure. Generally, the receiving surface of an object is a surface of the object which is suitable for the reception of an element. In various examples, the dimensional data obtained at block 410 may be analyzed to identify receiving surfaces of objects.

In the illustrated examples, the controller 102 analyzes the obtained dimensional data and identifies a receiving surface (e.g., label plane) of each object 114. In some examples, the receiving surface 500 may be a surface of the object 114 which is parallel to the plane of the conveyor 116 (e.g., an X-Y Plane) and not contacting the surface of the conveyor system 116. In some examples, the receiving surface 500 may be a surface of the object 114 which is not parallel to the plane of the conveyor system 116 (e.g., an X-Y Plane) and not contacting the surface of the conveyor system 116 such that a yaw, pitch, or roll of the end effector may need to be adjust to apply the element to the receiving surface 500.

FIG. 5 illustrates an example receiving surface 500 of an object 114. In some examples, the receiving surface 500 may be partitioned into sections. As illustrated in FIG. 5, the receiving surface 500 of the object 144 is partitioned into nine sections 502A-I, although other section quantities and formats are contemplated. In this manner, a user may specify which section 502 of the receiving surface 500 of each object 114 the element is applied to. For example, a user may specify that an adhesive label is to be applied to the upper right corner of each object 114, or the third section 502C. In some examples where an object 114 includes a pre-existing element or other media which is to be covered by the element applied by the end effector 108, the section 502 in which the pre-existing element or media is disposed in may be designated for receiving the element to be applied by the end effector 108.

Returning to FIG. 4, block 430 of the method 400 describes determining whether each receiving surface is reachable by the end effector, according to embodiments of the present disclosure. In the context of the system 100, the end effector 108 has a physical profile, as does the robotic device 110. The system 100 (e.g., or controller 102) may impose movement constraints on the robotic device 110, such that the position or integrity of the objects 114 is not affected by movements of the end effector 108 via the robotic device 110. Said differently, the robotic device 110 may be controlled such that neither the end effector 108 nor the robotic device 110 damage, dislodge, forcibly impact, interrupt or interfere with conveyance, or otherwise physically displace or deform any of the objects 114 during a course of motion.

Generally, the exterior profiles of the robotic device 110 and the end effector 108 are predetermined or otherwise known. Similarly, an operating speed of the robotic device 110 (e.g., or of the robotic arm) and the end effector are specified or otherwise known. Thus, for each object 114, there exists a predetermined spatial volume relative to the receiving surface 500 of the object 114 which the end effector 108 (e.g., and robotic device 110) will occupy for a given time while applying an element 115 to the receiving surface 500 of the object 114. In some examples, multiple objects 114 may be closely located on the conveyor system 116. In examples when one object 114 occupies at least a portion of the predetermined spatial volume of another object 114, the objects 114 are considered to be co-located.

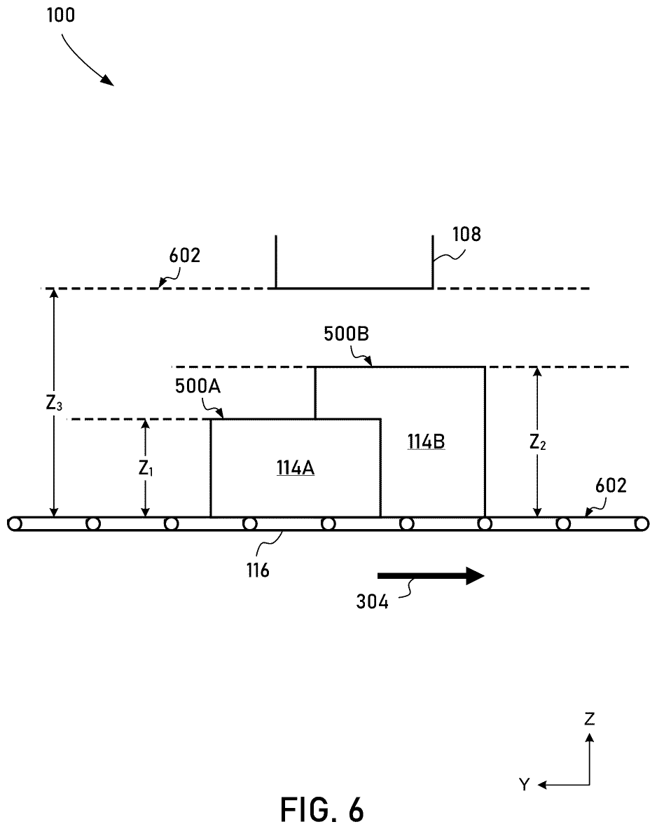

FIG. 6 illustrates a portion of the system 100, where a first object 114A and a second object 114B on the conveyor 116 are co-located. In the illustrated example, the first object 114A has a height Z₁ above the conveyor surface 602. The second object 114B has a height Z₂ above the conveyor surface 602, which is greater than Z₁. In the illustrated arrangement, the profile of the second object 114B occupies a portion of the predetermined spatial volume of the receiving surface 500A of the first object 114A. Due to the close proximity of the second object 114B to the first object 114A, if the end effector 108 is articulated to the receiving surface 500A of the first object 114A, the end effector 108 will contact the second object 114B, which may cause the second object to become dislodged or deformed and/or may interrupt or interfere with conveyance of the second object 114B. Said differently, the clearance to apply an element 115 to the first object 114A is not present due to the orientation and position of the second object 114B. Thus, the controller 102 may determine that the receiving surface 500A of the first object 114A is not reachable by the end effector 108 within the predetermined spatial volume constraints. Generally, if the predetermined spatial volume to be occupied by the end effector 108 when applying an element to a given object 114 is not occupied by another object 114 (e.g. or a portion thereof), then the receiving surface 500 of the given object 114 may be determined to be reachable by the end effector 108. When the predetermined spatial volume to be occupied by the end effector 108 when applying an element to a given object 114 is occupied by another object 114 (e.g. or a portion thereof), then the receiving surface 500 of the given object 114 may be determined to be unreachable by the end effector 108.

In various examples, the controller 102 may be configured to determine whether individual sections 502 of the receiving surface 500 of each object 114 are reachable by the end effector 108 within the constraints. In some examples, certain co-located objects 114 may render certain sections 502 of the receiving surface 500 of another object 114 unreachable by the end effector 108, but other sections may remain reachable by the end effector 108. In some such embodiments, the controller may be configured to make determinations as to the reachability of receiving surfaces 500 of objects based on analysis of one or more sections 502 of each receiving surface 500.

In some examples, upon determining that at least a portion of the receiving surface 500A of the first object 114A is unreachable by the end effector 108, the controller 102 may identify another surface of the object 114 which may be suitable as a receiving surface 500.

Returning to FIG. 4, block 440 of the method 400 describes classifying each object, according to embodiments of the present disclosure. After determining which receiving surfaces 500 are reachable by the end effector 108, the controller 102 classifies the objects 114 for which the receiving surface 500 of the object 114 is reachable by the end effector into a first plurality of objects 114, and classifies the objects 114 for which the receiving surface 500 (e.g., or each section 502 thereof) is unreachable by the end effector 108 into a second plurality of objects.

In various examples, the controller 102 may update the object identifiers of each object 114 to reflect the classification, such that the object identifier includes information indicating whether the object 114 is in the first plurality of objects 114 (e.g., reachable by the end effector 108) or in the second plurality of objects 114 (e.g., unreachable by the end effector 108).

Block 450 of the method 400 describes calculating a course of motion, according to embodiments of the present disclosure. In various examples, after identifying the objects 114 in the first plurality, the controller 102 calculates a course of motion for the robotic device 110 to articulate the end effector 108, such that the end effector 108 is appropriately positioned in space and time to apply an element to the receiving surface 500 of each object 114 in the first plurality of objects as the objects 114 are transported along the conveyor 116.

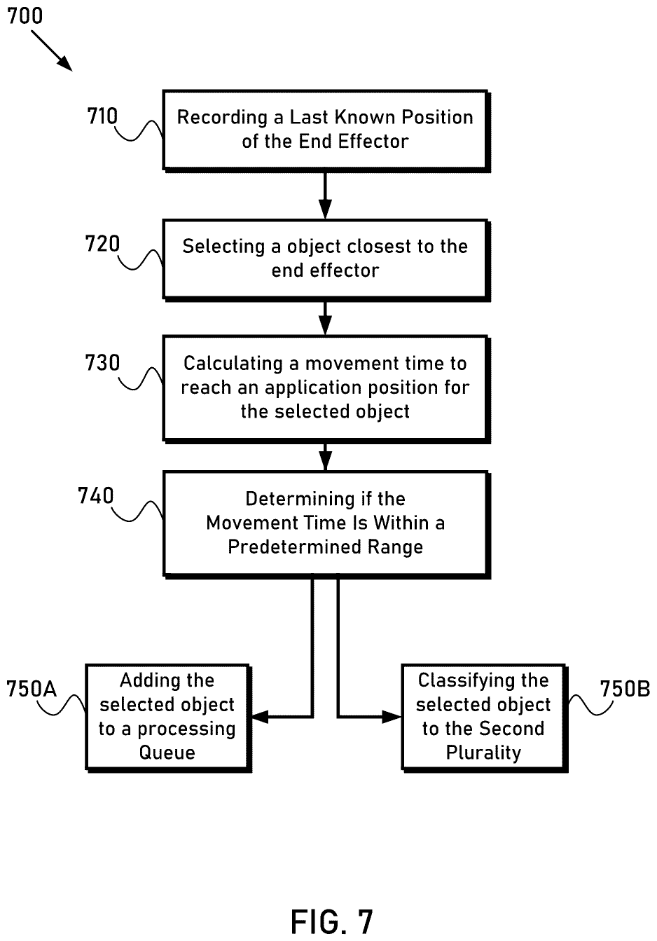

In various examples, calculating the course of motion may include a method of calculation. FIG. 7 illustrates a flowchart for an example method 700 of calculating the course of motion, according to embodiments of the present disclosure. In various examples, the method 700 may be conducted at block 450 of the method 400. Generally, the course of motion is a sequence of movements (e.g., as may be calculated by the controller 102) to articulate the end effector 108 between each object 114 in the first plurality of objects such that the end effector 108 is positioned at the correct points in space and time to apply an element 115 to each object 114.

Block 460 of the method 400 describes controlling the end effector apply an element to each object in the first plurality of objects, according to embodiments of the present disclosure. Once the course of motion has been calculated for the first plurality of objects (e.g., objects in the processing queue) the end effector 108 is controlled (e.g., by the robotic device 110) to apply an element to each of the objects 114 in the processing queue. In various examples, the robotic device 110 is controlled by the controller 102 to articulate the end effector 108 through the course of motion.

Block 470 of the method 400 describes the optional step of transporting the second plurality of objects, according to embodiments of the present disclosure. The second plurality of objects includes the objects 114 that are not reachable by the end effector 108. In various examples, the second plurality of objects may be transported through the application zone 118 of the system 100. In various examples, the second plurality of objects may be tended to by an apparatus downstream of the robotic device 110. In some examples, the second plurality of objects may be processed by the second robotic device 120, or flagged for removal, adjustment, or reprocessing.

Turning now to FIG. 7., an example method 700 for calculating the course of motion, as described in block 450 of the method 400. Block 710 of the method 700 describes recording the last known location of the end effector, according to embodiments of the present disclosure. In various examples, the last known position of the end effector 108 is a last computed location of the end effector 108, as there may be a temporal discrepancy between calculating the course of motion and articulating the end effector 108 through the course of motion (See block 460 of the method 400).

In some examples, the last known position of the end effector 108 may be the receiving surface of a previous object 114. In some examples, the last known position may be a “home position” of the end effector 108. Returning to FIG. 6, the home position of the end effector 108 may be a point defined in an X-Y plane having a height Z₃ above the conveyor surface 602.

The controller 102 may store (e.g., in a memory) the last known position of the end effector 108.

Block 720 of the method 700 describes selecting an object closest to the last known position of the end effector, according to embodiments of the present disclosure. Once the last known position of the end effector 108 is recorded, the controller 102 identifies an object which is closest to the last known position of the end effector. The controller 102 may process dimensional data obtained from the scan gate 306, such as described in block 410 of the method 400, and determine which object 114 is the closest to the last known position of the end effector 108. In various examples, a designated section 502 of a receiving surface 500 of an object 114 which is closest to the last know position of the end effector 108 may be selected.

Block 730 of the method 700 describes calculating a movement time to reach the selected object 114, according to embodiments of the present disclosure. The movement time is the time taken for the robotic device 110 to articulate the end effector 108 from the last known position of the end effector 108 to a position relative to the receiving surface 500 of the selected object 114, such that the end effector is aligned with the receiving surface 500 in a manner that an element 115 may be applied to the receiving surface 500 (e.g., in the designated section 502, where applicable) by the end effector 108. This position of the end effector 108 is referred to as the application position, and each object 114 may have a corresponding application position of the end effector 108.

In the process of calculating a movement time, a movement sequence may be determined. The robotic device 110 is configured to articulate the end effector 108 in 3 dimensions, as well as control a yaw, pitch and roll (e.g., rotation in each of the 3 dimensions) of the end effector 108. Prior to executing any articulation of the end effector 108, the controller calculates a path of articulation for the end effector 108 (e.g., to be executed by the robotic device 110) between the last known position of the end effector and application position for the selected object 114. Once the movement sequence is determined, the controller may calculate, based on known or predetermined operation speeds of the robotic device 110 and the conveyor 116, an amount of time the robotic device 110 will require to articulate the end effector 108 through the movement sequence.

Block 740 of the method 700 describes determining if the movement time is within a predetermined range, according to embodiments of the present disclosure. In various examples, the predetermined range is a period of time which corresponds to one or more factors relating to a media process which the end effector 108 is configured to execute. As a non-limiting example, the elements 115 processed by the end effector 108 may be adhesive labels which receive printed indicia by the end effector 108, and the end effector applies the adhesive labels to objects 114. In such an example, the predetermined range may be a period of time corresponding to the time required by the end effector 108 to print the indicia on the adhesive label. As a non-limiting example, the elements processed by the end effector 108 may include programable RF tags, and the predetermined range may be a period of time corresponding to the time required by the end effector 108 to program each RF tag.

In various examples, the predetermined period of time may correspond to a time required to print indicia on an element, a period of time required to program or encode an RF tag, NFC tag, or Bluetooth tag of an element 115, or a specified time threshold, as may be specified by a user or another system parameter.

In various examples, the predetermined range may also correspond to a throughput of objects along the conveyor 116. In some instances where a throughput of objects a long the conveyor system is relatively low, the predetermined range may include a greater period of time, as there are greater distances or greater periods of time between sequential objects 114 on the conveyor 116. Conversely, in instances where the throughput of objects 114 along the conveyor 116 is relatively high, the predetermined range may include smaller periods of time, as there are smaller distances or smaller periods of time between sequential objects 114 on the conveyor 116.

Blocks 750A-B of the method 700 describe actions based on the determinations made in block 740 of the method 700.

Block 750A describes associating the selected object with the first plurality of objects and adding the selected object to a processing queue, according to embodiments of the present disclosure. In various examples, when the movement time is determined to be within the predetermined range, the corresponding object 114 is assigned to a processing queue. In various examples, the processing queue may be a queue of objects 114 for which movement times have been calculated (e.g., such as at block 730) and determined to be within the predetermined range (e.g., such as at block 740). In various examples, the processing queue may be stored in a memory of the controller 102. In various examples, the processing queue may include object identifiers, movement sequences, and other information.

Block 750B describes classifying the selected object to the second plurality of objects, according to embodiments of the present disclosure. In some examples, when the movement time is outside of the predetermined range, the selected object 114 is classified to the second plurality of objects 114. Generally, the second plurality of objects 114 includes the objects 114 which are unreachable by the end effector 108.

After the actions of blocks 750A-B, the method 700 may be iterated for each sequential object 114. In various examples, when the selected object 114 is assigned to the processing queue, the last known position of the end effector is updated to the application position of the selected object 114. In various examples, when the selected object is classified to the second plurality of objects, the last known position of the end effector remains the same, and the method 700 is iterated from block 720, where the object 144 which is closest to the last known position of the end effector 108, excluding the previously selected object 114, is selected.

In various examples, the processing queue includes at least the object identifiers in an order determined by iterating the method 700.

In various examples, the course of motion referenced in block 450 of the method 400 may be a concatenated sequence of each movement sequence determined in block 730 of the method 300. When the selected object is added to the processing queue, the corresponding movement sequence is added to the course of motion. When the selected object 114 is classified to the second plurality of objects 114, the calculated movement sequence may be discarded.

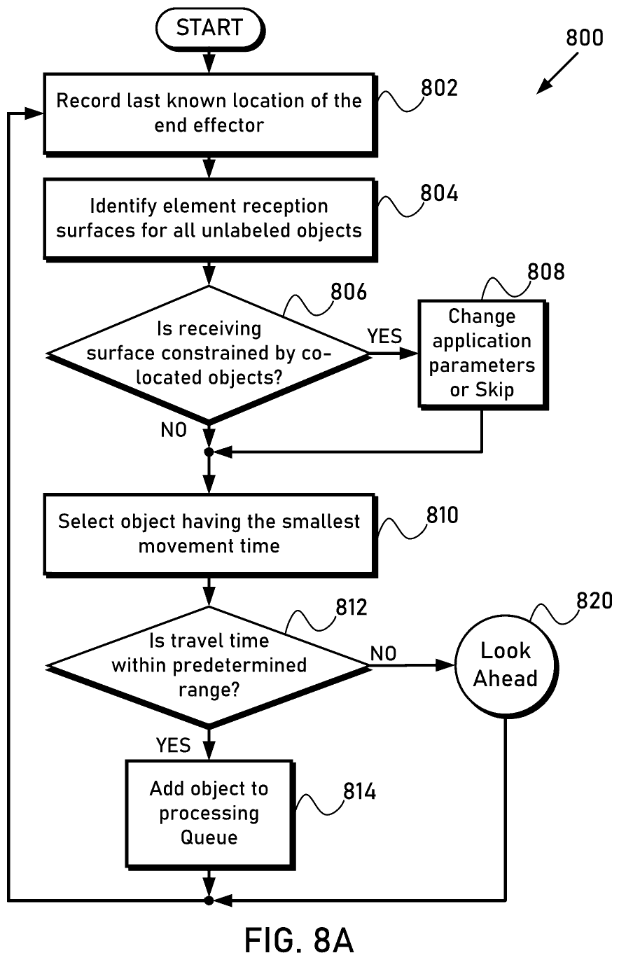

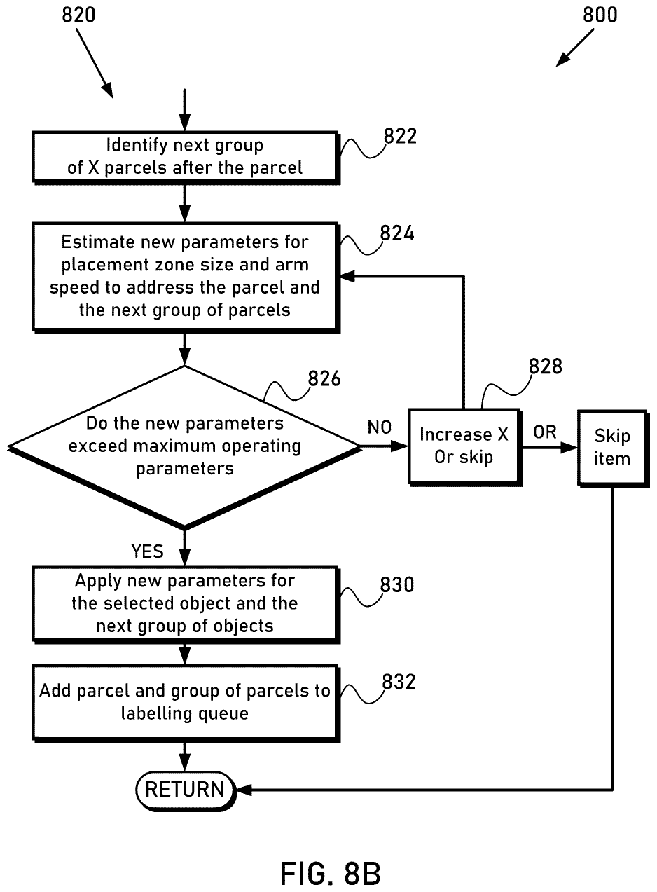

FIGS. 8A-8B illustrate a logic function of an example method 800, as may be implemented or executed by the controller 102, according to embodiments of the present disclosure. First, at a first process block 802, the last known position of the end effector 108 is recorded, e.g., as described in block 710 of the method 700. Then, at a second process block 804 the receiving surface 500 of each object is identified, e.g., as is described at block 420 of the method 400. Then, at a first decision block 806, the controller 102 identifies whether the receiving surface 500 of each object is constrained by a co-located object 114. When a co-located object is identified, the method proceeds to a third process block 808, where the co-located object 114 may be classified to the second plurality (e.g., skipped). In some examples, the end effector 108 may be equipped to have alternative application parameters. In some examples, the end effector 108 may be configured to process an element 115 and directly apply the element to the object 114 with a tamper, or similar component. However, the end effector may also be equipped with a blowing apparatus, which is configured to apply the element 115 to the object from a distance by blowing the element out of the end effector 108. In some examples, blowing the element 115 may provide for the end effector 108 to apply elements to co-constrained objects 114 without impacting the constraining object 114. In such examples, the object 114 may be classified to the first plurality of objects, and information is stored such that when the movement sequence is calculated for the object 114, the movement sequence is calculated based on the positional requirements for the alternative application parameter (e.g., blowing the element 115).

Next, at a fourth process block 810, the object having the smallest movement time is selected, e.g., as is described in blocks 720 and 730 of the method 700.

Next, at a second decision block 812, the controller determines whether the movement time is within a predetermined range, e.g., as is discribed at block 740 of the method 700.

If the movement time is within the predetermined range, the method proceeds to process block 814, where the selected object 114 is added to the processing queue. If the movement time is not within the predetermined range, the controller engages in a look-ahead function 820, illustrated in FIG. 8B.

In the look-ahead function 820, at a fifth process block 822 the controller identifies the next group of objects which are consecutively sequential to the selected object 114. The next group of objects may have a predetermined quantity, X. At a sixth process block 824, the controller then estimates new operational parameters for the size of the application zone 118 (e.g., by controlling the robotic device 110 to articulate the end effector 108 in the upstream zone 310 or the downstream zone 320) and the speed of the robotic device 110 in order to address (e.g., apply elements 115 to) the selected object 114 and the next group of objects 114. At a third decision block 826, the estimated parameters are analyzed. If the estimated parameters exceed the maximum operating parameters of the system 100, the method proceeds to a seventh process block 828 where the value of X or the number of objects 114 in the next group of objects 114 is increased, and the method returns to sixth process block 824 where the new parameters are estimated. In some examples, this sequence between the sixth process block 824 and the seventh process block 828 may be iterated until the estimated parameters are within the maximum operating parameters of the system 100, or until an iteration threshold is reached. In some examples, when an iteration threshold is reached, the selected object 114 may be skipped.

If the estimated parameters do not exceed the maximum operating parameters of the system, then the method 800 proceeds to an eight process block 830 where controller applies the new parameters to the selected object and the next group of objects. Next the method 800 proceeds to a ninth process block 832, where the controller 102 adds the selected object and the next group of objects to the processing queue. The new parameters may be used to calculate the movement sequences for the selected object and the next group of objects. After the look-ahead function is executed, the last known position of the end effector 108 is updated to the application position of the final object 114 in the next group of objects, and the parameters are returned to the nominal operating parameters for processing the subsequent objects 114.

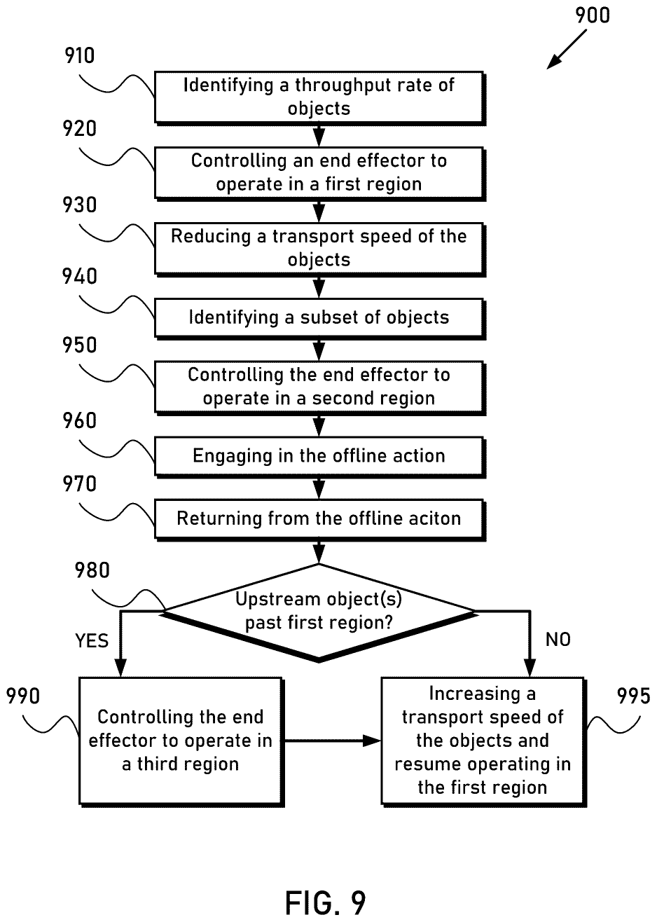

FIG. 9 illustrates an example method 900 of maintaining throughput of an object transport and processing system, according to embodiments of the present disclosure. In various examples, the method may be employed when the system 100 while the system 100 (e.g., the robotic device 110 and/or end effector 108s of the system 100) engages in an offline action, such as an action to resupply or replenish media (e.g., elements 115) to an end effector 108 or to swap a first end effector 108A for a second end effector 108B. Generally, the offline action may be any action taken by the robotic device 110 during which the robotic device ceases to articulate the end effector 108 and/or the end effector ceases to apply elements 115 to objects 114.

Block 910 of the method 900 describes identifying a throughput rate of objects, according to embodiments of the present disclosure. In various examples, a throughput rate of objects being transported along a processing path are identified. A controller may analyze dimensional data and determine a throughput rate of objects along a processing path based on the dimensional data and a conveyance speed of the conveyor system (e.g., conveyor system 116). In various examples, the throughput rate of objects through the system may be identified in terms of objects per unit of time. In various examples, the throughput rate of objects through the system may be between 60 and 3600 objects per hour, although other throughput rates are contemplated.

In a contextual example of the system 100, the controller 102 may analyze dimensional data received from the scan gate 306 to identify objects 114 and determine a throughput rate of the objects 114 along the conveyor per unit time.

Block 920 describes controlling an end effector to operate in a first region (e.g., the application zone 118), according to embodiments of the present disclosure. In various examples, a controller may control a robotic device to articulate the end effector to apply elements to objects in the first region. In various examples, the end effector may be controlled to apply the elements according to nominal operating conditions, including a specified transport speed of objects, a specified operating speed of the robotic device, a specified operating speed of the end effector (e.g., a specified print speed), and specified dimensions of the first region. In various examples, under the nominal operating conditions, the robotic device may be controlled to articulate the end effector exclusively or with minimal deviation in a first direction perpendicular to a direction of the processing path, a second direction perpendicular to both the first direction and the direction of the processing path and articulate the end effector rotationally about an axis parallel with the second direction.

In a contextual example of the system 100, the controller 102 controls the robotic device 110 to articulate the end effector 108 in the application zone 118 to apply elements 115 to objects 114 which are transported along the processing path by the conveyor 116. The controller 102 may operate the robotic device 110 and the end effector 108 according to nominal operating conditions, including a specified speed of the conveyor 116, a specified speed of the robotic device 110, a specified operating speed (e.g., print speed) of the end effector, and specified dimensions of the application zone 118. The controller 102 may control the robotic device 110 to articulate the end effector 108 in the X direction, the Y direction, the Z direction, and rotate the end effector 108 relative to the Z axis.

Block 930 of the method 900 describes an optional step of reducing the speed of the conveyor system to reduce the transport speed of objects, according to embodiments of the present disclosure. In various examples, the transport speed of objects along the processing path may be reduced in advance of the offline action. In various examples, when the throughput rate identified at block 910 is in excess of a first predetermined threshold, the processing path may be controlled such that transport speed of objects along the processing path is reduced. In various examples, the speed of the conveyor system may be reduced causing the transport speed of the objects to be reduced. As an example, the speed of the conveyor system can be reduced from a first speed to a second speed (such that the transport speed of the object is reduced from the first speed to the second speed). In various examples, the second speed may be between 50% and 95% of the first speed, although the second speed may be any speed which is less than the first speed.

In a contextual example of the system 100, the controller 102 controls the speed of the conveyor 116, and may reduce the speed of the conveyor system 116 in advance of the offline action responsive to the throughput rate exceeding the first predetermined threshold.

Block 940 of the method 900 describes identifying a first subset of the objects, according to embodiments of the present disclosure. In various examples, the first subset of the objects includes the objects that will pass through the first region (e.g., the application zone) during the offline action. In various examples, the first subset of the objects includes objects which have yet to enter the first region. In various examples, the first subset of the objects is identified such that if elements were applied to each of the objects in the first subset of the objects prior to a particular object in the first subset of the objects entering the first region, then the offline action could be performed and returned from, prior to an object which is immediately subsequent to the first subset of the objects exiting the first region.

In various examples, the first subset of the objects is identified such that if elements were applied to each of the objects in the first subset of the objects prior to a particular object in the first subset of the objects entering the first region, then the offline action could be performed and returned from, prior to an object which is immediately subsequent to the first subset of the objects exiting a third region which is downstream of the first region along the processing path (e.g., the downstream zone). Some such examples include scenarios when the throughput rate identified at block 910 exceeds the first predetermined threshold. Some such examples include scenarios when the throughput rate identified at block 910 exceeds a second predetermined threshold, greater than the first predetermined threshold.

In various examples, the first subset of the objects is identified based on a throughput rate identified at block 910. In various examples, the first subset of the objects is identified based on the throughput rate identified at block 910 adjusted for a transport speed of objects reduced at block 930. In various examples, the first subset of the objects is identified based on the nominal operating conditions.

In a contextual example of the system 100, the controller 102 identifies a first subset of the objects 114 such that if elements 115 were applied by the end effector 108 to each of the objects 114 in the first subset of the objects 114 prior to a particular object 114 in the first subset of the objects 114 entering the application zone 118, then the offline action could be performed and returned from, prior to an object 114 which is immediately subsequent to the first subset of the objects 114 exiting the application zone 118.

In another example in the context of the system 100, when the throughput rate exceeds the second predetermined threshold, the controller 102 identifies a first subset of the objects 114 such that if elements 115 were applied by the end effector 108 to each of the objects 114 in the first subset of the objects 114 prior to a particular object 114 in the first subset of the objects 114 entering the application zone 118, then the offline action could be performed and returned from, prior to an object 114 which is immediately subsequent to the first subset of the objects 114 exiting the downstream zone 320.

Block 950 of the method 900 describes controlling the end effector to operate in a second region, according to embodiments of the present disclosure. In various examples, the end effector of the robotic device is controlled to extend an operation of the end effector of the robotic device to a second region which is upstream of the first region along the processing path to apply elements to each of the objects in the first subset in advance of the offline action. In various examples, the robotic device may be controlled to articulate the end effector along three mutually perpendicular axes, including rotation about each axis in order to apply elements to each of the objects in the first subset of the objects in the second region.

In a contextual example of the system 100, the controller 102 expands the application zone 118 into the upstream zone 310 and controls the robotic device 110 and end effector 108 to apply elements 115 to the first subset of the objects 114.

Block 960 of the method 900 describes engaging in the offline action according to embodiments of the present disclosure. In various examples the offline action may include replenishing media to an end effector, exchanging an end effector, or other media replenishment action. Generally, the offline action is an action during which elements are not applied to objects by the end effector.

In the context of the system 100, the controller 102 may control the robotic device 110 to articulate a first end effector 108a to the docking station 106 and exchange the first end effector 108a for a second end effector 108b, or replenish the media supply of the first end effector 108a.

Block 970 of the method 900 describes returning from the offline action, according to embodiments of the present disclosure. In various examples, the end effector of the robotic device may be controlled to return to the first region or the third region. The first region is downstream from the second region and the third region is downstream from the first and second regions along the processing path

Block 980 of the method 900 describes determining whether to resume operation of the end effector in the first region or the third region based on an estimated or known position of an object or objects upstream (upstream object(s)) of the first subset of objects. The cameras and/or sensor of the system can track the position of the upstream object(s) and/or a position of the objects relative to the first region can be estimated based on the transport speed during the offline action and a time elapsed while in the offline action.

In various examples, the end effector is returned to the first region when an estimated or known position of the upstream object(s) is upstream of the first region or is within the first region (e.g., after the upstream object(s) enter the first region but before the upstream objects exit the first region). In various examples, the end effector is returned when the estimated or known position of the upstream object(s) is downstream of the first region and in the third region (e.g., after the upstream object(s) enter the third region but before the upstream objects exiting the third region).

In a contextual example of the system 100, the controller 102 controls the robotic device 110 to articulate the end effector 108 (e.g., 108b) to the first region (e.g., the application zone 118) prior to an upstream one of the objects 114 which is immediately subsequent to the first subset of the objects 114 exiting the third region or controls the robotic device 110 to articulate the end effector 108 (e.g., 108b) to the third region (e.g., the downstream zone 320) prior to an upstream one of the objects 114 which is immediately subsequent to the first subset of the objects 114 exiting the third region.

Block 990 of the method 900 describes controlling the end effector to operate in the third region, according to embodiments of the present disclosure. In various examples, the end effector of the robotic device is controlled to extend an operation of the end effector of the robotic device to a third region downstream of the first region along the processing path to apply elements to a second subset of the objects (upstream object(s)) arriving in the third region after the first subset of the objects upon return from the offline action. The second subset of objects passed through the first region during the offline action and did not receive the elements from the end effector in the first region. In various examples, the actions of block 990 further include increasing the operating speed of the robotic device and/or increasing an operating speed of the end effector (e.g., increasing a print speed of the end effector). In this manner, the end effector of the robotic device may be controlled to apply elements to each object in the second subset of the objects in the third region and return to the first region once each of the objects in the second subset of elements has had an element applied thereto. In various examples, the second subset of the objects is identified such that if elements were applied to each of the objects in the second subset of the objects prior to a particular object in the second subset of the objects exiting the first region, then the end effector of the robotic device could be controlled to operate only in the first region without any objects being transported through the first region, the second region, or the third region without receiving elements.

In a contextual example of the system 100, the controller 102 expands the application zone 118 into the downstream zone 320 and controls the robotic device 110 to articulate the end effector 108 to apply elements 115 to second subset of the objects 114 arriving in the downstream zone without first receiving the elements from the end effector in the application zone 118 due to the offline action. The controller 102 may also increase the operating speed of the robotic device 110 and/or the operating speed of the end effector (e.g., the print speed) such that dimensions of the application zone 118 may be returned to the nominal dimensions (e.g., to exclude the downstream zone 320) to resume applying elements 115 to the objects 114 being transported through the application zone 118 without skipping reachable objects. Generally, the controller 102 increases the speed of the robotic device 110 and/or the operation speed of the end effector to “catch up” by applying elements to each of the objects in the second subset of the objects 114 and subsequently return to nominal operating conditions.

Block 995 of the method 900 describes increasing a transport speed of the objects and resuming operation in the first region, according to embodiments of the present disclosure. In various examples, the end effector of the robotic device is controlled to resume operating within the first region of the processing path to apply elements to the objects arriving in the first region. As an example, after the elements are applied to the second subset of the objects by expanding the operation of the end effector to the third region (e.g., the downstream zone), and the end effector has “caught up”, the system can resume operating in the first region (e.g., the activation zone. As another example, when it is determined that the end effector may return from the offline action and resume operation in the first region without missing any objects, the system may resume operation after the offline action with the end effector in the first region (e.g., the apply elements to the second subset of objects as the second subset of objects pass through the first region). In various examples, the actions of block 995 describe returning to nominal operating conditions. In examples where the transport speed of objects was reduced at block 930, the transport speed of objects is increased from the second speed to the first speed at block 995.

In a contextual example of the system 100, the controller 102 increases the speed of the conveyor 116 to the nominal speed of the conveyor 116 (e.g., where applicable), decreases the operating speed of the robotic device 110 to the nominal operating speed of the robotic device 110 (e.g., where applicable), decreases the operating speed (e.g., the print speed) of the end effector 108 to the nominal operating speed of the end effector (e.g., where applicable), and/or decreases the dimensions of the application zone to the nominal dimensions of the application zone 118 (e.g., where applicable).

After the actions of block 995, the method 900 may be concluded until the next offline action.

In various examples, the method may be devoid of block 980 and may proceed from block 970 to block 990 automatically after returning from an offline action such that the system 100 begins operating in the third region (e.g., the downstream zone 320) after the offline action before returning operation to the first region (e.g., the activation zone 118) at block 995. In various examples, the method may be devoid of blocks 980 and 990 and may proceed from block 970 to block 995 automatically after returning from an offline action such that the system 100 begins operating in the first region (e.g., the activation zone 118) after the offline action.

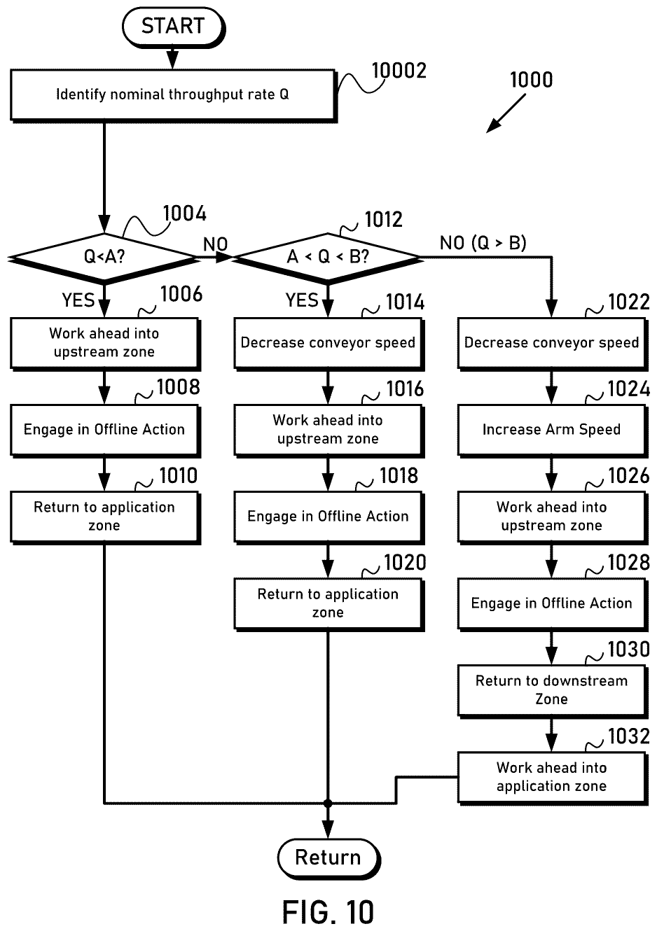

FIG. 10 illustrates a logic function of an example method 1000, as may be implemented or executed by the controller 102, according to embodiments of the present disclosure. First, at a first process block 1002, the nominal throughput rate is identified, e.g., as is described at block 910 of the method 900, and assigned a value, for example, Q.

After Q is identified, the method 1000 proceeds to a first decision block 1004 where Q is analyzed. If Q is less than a first predetermined threshold A, the method 1000 proceeds to a second process block 1006 where the controller 102 controls the robotic device 110 to apply elements 115 to the objects in the first subset of the objects 114, e.g., as described in blocks 940 and 950 of the method 900. The method 1000 then proceeds to a third process block 1008 where the controller 102 controls the system 100 to engage in an offline action (e.g., as described in block 960 of the method 900). Then the method 1000 proceeds to a fourth process block 1010, where the controller 102 controls the robotic device 110 to return to the application zone 118 (e.g., as described in block 970 of the method 900).

If Q is greater than a throughput threshold A, the method proceeds to a second decision block 1012, where Q is further analyzed. If Q is less than a second predetermined throughput threshold, B, (e.g., and larger than A) then the method proceeds to a fifth process block 1014, where controller 102 reduces the speed of the conveyor and a sixth process block 1016 where the robotic device 110 is controlled to apply elements 115 to the objects in the first subset of the objects 114, e.g., as described in blocks 940 and 950 of the method 900. Then, at a seventh process block 1018, the controller 102 controls the system 100 to engage in the offline action (e.g., as described in block 960 of the method 900), and at an eighth process block 1020, controls the robotic device to return to the application zone 118 (e.g., as described in block 970 of the method 900). The controller may then control the system 100 to return to nominal operating conditions.

If Q is greater than throughput threshold B, then, at a ninth process block 1022 the controller 102 reduces the speed of the conveyor. Then, at a tenth process block 1024, the controller increases an arm speed of the robotic device 110. Then, at an eleventh process block 1026, the controller 102 controls the robotic device 110 to apply elements 115 to the objects in the first subset of the objects 114 in the upstream zone 310, e.g., as described in blocks 940 and 950 of the method 900. Then at a twelfth process block 1028 the controller 102 controls the system 100 to engage in the offline action (e.g., as described in block 960 of the method 900), and at a thirteenth process block 1030, operates in the downstream zone 320 upon returning from the offline action, e.g., as described in block 980 of the method 900. Then at a fourteenth process block 1032, the controller controls the robotic device 110 to work ahead into the application zone 118. After the actions of fourth process block 1010, eighth process block 1020 or fourteenth process block 1032, the controller may then control the system 100 to return to nominal operating conditions.

In the foregoing specification, specific embodiments have been described. However, one of ordinary skill in the art appreciates that various modifications and changes can be made without departing from the scope of the technology the present disclosure as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any manner. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain manner is configured in at least that manner but may also be configured in manner that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, relevant subject matter may lie in less than all features of a single disclosed embodiment. Thus, the following claims are hereby incorporated into the Detailed Description, with each claim standing on its own as a separately claimed subject matter.

1. A method of maintaining object throughput of an object transport and processing system, the method comprising:
identifying a throughput rate of objects being transported along a processing path;
controlling an end effector of a robotic device to operate in a first region of the processing path to apply elements to the objects;
identifying a first subset of the objects that will pass through the first region during an offline action during which the end effector ceases to apply the elements to the objects;
controlling the end effector of the robotic device to extend an operation of the end effector of the robotic device to a second region upstream of the first region along the processing path to apply elements to each of the objects in the first subset in advance of the offline action; and
engaging in the offline action.

2. The method of claim 1, further comprising:
returning from the offline action; and
controlling the end effector of the robotic device to resume operating within the first region of the processing path to apply elements to the objects arriving in the first region after the first subset of the objects.

3. The method of claim 1, further comprising:
reducing a transport speed of the objects along the processing path from a first speed to a second speed in advance of the offline action in response to determining the throughput rate exceeds a threshold rate;
returning from the offline action; and
in response to returning from the offline action, increasing the transport speed of the objects along the processing path from the second speed to the first speed.

4. The method of claim 3, wherein the second speed is between 50% and 95% of the first speed.

5. The method of claim 1, further comprising:
returning from the offline action; and
controlling the end effector of the robotic device to extend an operation of the end effector of the robotic device to a third region downstream of the first region along the processing path to apply elements to a second subset of the objects that arriving in the third region after the first subset of the objects without first receiving the elements from the end effector in the first region.

6. The method of claim 5, wherein controlling the robotic device to apply elements to the second subset of the objects in the third region includes increasing an operating speed of the robotic device.

7. The method of claim 5, further comprising:
controlling the end effector of the robotic device to resume operating within the first region of the processing path to apply elements to the objects arriving in the first region after the elements are applied to the second subset of the objects.

8. The method of claim 1, wherein the end effector includes a thermal printing device.

9. The method of claim 1, wherein the elements include adhesive labels.

10. The method of claim 1, wherein the elements include radiofrequency identification (RFID) tags, near-field communication (NFC) tags, or Bluetooth tags.

11. The method of claim 1, wherein the throughput rate is between 60 and 3600 objects per hour (PPH).

12. A object processing system, comprising:
an end effector operatively coupled to a robotic device, the end effector configured to apply elements to objects being transported along a processing path; and
a logic circuit, configured to:
identify a throughput rate of objects being transported along a processing path;
control the end effector of a robotic device to operate in a first region of the processing path to apply elements to the objects;
identify a first subset of the objects that will pass through the first region during an offline action in which the end effector ceases to apply the elements to the objects;
control the end effector of the robotic device to extend an operation of the end effector of the robotic device to a second region upstream of the first region along the processing path to apply elements to each of the objects in the first subset in advance of the offline action; and
engage in the offline action.

13. The object processing system of claim 12, wherein the logic circuit is further configured to:
return from the offline action; and
control the end effector of the robotic device to resume operating within the first region of the processing path to apply elements to the objects arriving in the first region after the first subset of the objects.

14. The object processing system of claim 13, wherein the logic circuit is configured to:
reduce a transport speed of the objects along the processing path from a first speed to a second speed in advance of the offline action in response to determining the throughput rate exceeds a threshold rate;
return from the offline action; and
in response to returning from the offline action, increasing the transport speed of the objects along the processing path from the second speed to the first speed.

15. The object processing system of claim 14, wherein the second speed is between 50% and 95% of the first speed.

16. The object processing system of claim 12, wherein the logic circuit is configured to:
return from the offline action; and
control the end effector of the robotic device to extend an operation of the end effector of the robotic device to a third region downstream of the first region along the processing path to apply elements to a second subset of the objects that arriving in the third region after the first subset of the objects without first receiving the elements from the end effector in the first region.

17. The object processing system of claim 16, wherein the logic circuit is configured to increasing an operating speed of the robotic device.

18. The object processing system of claim 16, wherein the logic circuit is configured to:
control the end effector of the robotic device to resume operating within the first region of the processing path to apply elements to the objects arriving in the first region after the elements are applied to the second subset of the objects.

19. The object processing system of claim 12, wherein the end effector includes a thermal printing device.

20. The object processing system of claim 12, wherein the elements include adhesive labels.

21. The object processing system of claim 12, wherein the elements include radiofrequency identification (RFID) tags or near-field communication (NFC) tags.

22. The object processing system of claim 12, wherein the throughput rate is between 60 and 3600 objects per hour.
